(19) United States
(12) Patent Application Publication
(10) Pub. No.: US 2019/0049763 A1
(43) Pub. Date: Feb. 14, 2019

(54) MANUFACTURING METHOD OF DISPLAY APPARATUS

(71) Applicants: HKC Corporation Limited, Shenzhen City (CN); Chongqing HKC Optoelectronics Technology Co., ltd., Chongqing (CN)

(72) Inventor: YU-JEN CHEN, Chongqing (CN)

(21) Appl. No.: 15/856,735

(22) Filed: Dec. 28, 2017

Related U.S. Application Data
(63) Continuation of application No. PCT/CN2017/116145, filed on Dec. 14, 2017.

(30) Foreign Application Priority Data
Aug. 8, 2017 (CN) 201710670744.8

(51) Int. Cl. G02F 1/1337; G02F 1/1335; G02F 1/1362

(52) U.S. Cl. CPC G02F 1/1337; G02F 1/136286; G02F 1/133528

(57) ABSTRACT

The disclosure provides a manufacturing method of a display apparatus, including: providing a first substrate, forming a first alignment layer on the first substrate, exposing the first alignment layer on the first substrate for alignment with using a first light source, providing a second substrate, forming a second alignment layer on the second substrate, injecting liquid crystals between the first substrate and the second substrate and assembling the first substrate and the second substrate to form the display apparatus, exposing the second alignment layer on the second substrate for alignment with using a second light source; the first alignment layer and the second alignment layer are provided on opposite sides of the first substrate and the second substrate respectively.

### FIELD OF THE DISCLOSURE

Embodiments of the disclosure relate to a display technology, and more particularly to a manufacturing method of a display apparatus.

### BACKGROUND

Generally, the alignment layer in the array substrate and the color filter substrate is aligned; the liquid crystal molecules are packaged between the array substrate and the color filter substrate, and the liquid crystal molecules are aligned under the action of the alignment layer. The alignment of liquid crystal molecules mainly adopts two kinds of alignment methods, namely friction alignment and optical alignment. Friction alignment produces static electricity and particle contamination, while the optical alignment is a relatively better alignment method.

The process of forming the alignment layer on the color filter substrate using the optical alignment technique is: processing an illumination treatment of the alignment layer through a mask plate via light with a certain power and wavelength such as ultraviolet light. The mask plate includes a light transmissive area and a light tight area; the light transmissive area on the mask plate needs to correspond to the area to be aligned in the alignment layer on the color filter substrate, thus a light shielding layer or a spacer is necessary to be used as a reference to align the mask plate and the color filter substrate. However, with respect to the display apparatus with light shielding layer and spacer placed on the array substrate, the alignment layer in the color filter substrate is impossible to be exposed for alignment, and then the liquid crystal molecules are impossible to be aligned.

### SUMMARY

The embodiment of the disclosure provides a manufacturing method of a display apparatus to align liquid crystal molecules in a display apparatus with a light shielding layer and a spacer placed on a first substrate.

The embodiment of the disclosure provides a manufacturing method of a display apparatus, and the method includes: providing a first substrate, forming a first alignment layer on the first substrate, exposing the first alignment layer on the first substrate for alignment with using a first light source, providing a second substrate, forming a second alignment layer on the second substrate, injecting liquid crystals between the first substrate and the second substrate, and assembling the first substrate and the second substrate to form the display apparatus, exposing the second alignment layer on the second substrate for alignment with using a second light source; the first alignment layer and the second alignment layer are provided on opposite sides of the first substrate and the second substrate respectively.

Optionally, a direction of a molecular chain of the first alignment layer after exposing the first alignment layer on the first substrate for alignment is perpendicular to a direction of a molecular chain of the second alignment layer after exposing the second alignment layer on the second substrate for alignment.

Optionally, the first substrate includes data lines and scanning lines; the data lines and the scanning lines are insulated and crossed to define sub-pixels; each of the sub-pixels includes display domains.

The directions of the molecular chains of the first alignment layer of the first substrate corresponding to two adjacent display domains are opposite along an extension direction of the data lines; the directions of the molecular chain of the first alignment layer of the first substrate corresponding to two adjacent display domains are identical along an extension direction of the scanning lines; the directions of the molecular chains of the second alignment layer of the second substrate corresponding to two adjacent display domains are opposite along the extension direction of the scanning lines; the directions of the molecular chains of the second alignment layer of the second substrate corresponding to two adjacent display domains are identical along the extension direction of the data lines; or, the directions of the molecular chains of the first alignment layer of the first substrate corresponding to two adjacent display domains are opposite along the extension direction of the scanning lines; the directions of the molecular chains of the first alignment layer of the first substrate corresponding to two adjacent display domains are identical along the extension direction of the data lines; the directions of the molecular chains of the second alignment layer of the second substrate corresponding to two adjacent display domains are opposite along the extension direction of the data lines; the directions of the molecular chains of the second alignment layer of the second substrate corresponding to two adjacent display domains are identical along the extension direction of the scanning lines.

Optionally, the first substrate includes the data lines and the scanning lines; the data lines and the scanning lines are insulated and crossed to define the sub-pixels; each of the sub-pixels includes a first display domain, a second display domain, a third display domain, and a fourth display domain arranged in a 2×2 matrix; the first display domain and the second display domain are arranged in a same row; the third display domain and the fourth display domain are arranged in a same row; the first display domain and the third display domain are arranged in a same column; the second display domain and the fourth display domain are arranged in a same column.

Exposing the first alignment layer on the first substrate for alignment with using the first light source includes following steps.

The first alignment layer on the first substrate corresponding to the first display domain and the third display domain is exposed for alignment; a first mask plate exposes the first display domain and the third display domain of each of the sub-pixels, such that the direction of the molecular chain of the first alignment layer on the first substrate corresponding to the first display domain and the third display domain is a first direction.

The first alignment layer on the first substrate corresponding to the second display domain and the fourth display domain is exposed for alignment; the first mask plate exposes the second display domain and the fourth display domain of each of the sub-pixels, such that the direction of the molecular chain of the first alignment layer on the first substrate corresponding to the second display domain and the fourth display domain is a second direction; the first direction is opposite to the second direction.

Exposing the second alignment layer on the second substrate for alignment with using the second light source includes following steps.

The second alignment layer on the second substrate corresponding to the first display domain and the second display domain is exposed for alignment; a second mask plate exposes the first display domain and the second display domain of each of the sub-pixel, such that the direction of the molecular chain of the second alignment layer on the second substrate corresponding to the first display domain and the second display domain is a third direction.

The second alignment layer on the second substrate corresponding to the third display domain and the fourth display domain is exposed for alignment; the second mask plate exposes the third display domain and the fourth display domain of each of the sub-pixel, such that the direction of the molecular chain of the second alignment layer on the second substrate corresponding to the a third display domain and the fourth display domain is a fourth direction; the third direction is opposite to the fourth direction.

Optionally, the first alignment layer is a photo-cleavable type alignment polyimide film; the second alignment layer is a photopolymerizable type alignment polyimide film.

Optionally, the first light source emits light of a first wavelength; the second light source emits light of a second wavelength; the first wavelength is in a range of 254 nm to 365 nm; the second wavelength is in a range of 254 nm to 365 nm.

Optionally, the first substrate includes data lines and scanning lines; before exposing the first alignment layer on the first substrate for alignment with using the first light source, the method also includes a following step.

A first mask plate and the first alignment layer are aligned with using the data lines and the scanning lines as aligning marks.

Before exposing the second alignment layer on the second substrate for alignment with using the second light source, the manufacturing method also includes a following step.

A second mask plate and the second alignment layer are aligned with using the data lines and the scanning lines as aligning marks.

Optionally, the first light source emits light of a first wavelength; the second light source emits light of a second wavelength; the light of the first wavelength and the light of the second wavelength are polarized light; a direction of polarization of the light of the first wavelength is the same as a direction of polarization of the light of the second wavelength, and a direction of irradiation and scanning of the light of the first wavelength is orthogonal to a direction of irradiation and scanning of the light of the second wavelength.

Optionally, the first substrate includes a light shielding layer and a spacer; the manufacturing method also includes forming a pixel array on the first substrate and forming a photoresist on the second substrate; the pixel array is located between the first substrate and the first alignment layer; the photoresist is located between the second substrate and the second alignment layer.

Optionally, the first substrate includes a light shielding layer and a spacer; the manufacturing method also includes forming a pixel array and a photoresist on the first substrate; the pixel array is located between the first substrate and the first alignment layer.

Optionally, the first substrate and the second substrate are assembled through a sealant.

Optionally, light emitted from the first light source irradiates the first alignment layer so that molecular chains in the first alignment layer are oriented in a specific direction, playing a role of admitting liquid crystal molecules to form a pre-tilt angle.

Optionally, light emitted from the second light source irradiates the second alignment layer so that molecular chains in the second alignment layer are distributed in a specific direction, playing a role of admitting liquid crystal molecules to form a pre-tilt angle.

The embodiment of the disclosure provides a manufacturing method of a display apparatus; the manufacturing method includes: providing a first substrate; forming a first alignment layer on the first substrate; exposing the first alignment layer on the first substrate for alignment with using a first light source, providing a second substrate, forming a second alignment layer on the second substrate, injecting liquid crystals between the first substrate and the second substrate, and assembling the first substrate and the second substrate to form the display apparatus; exposing the second alignment layer on the second substrate for alignment with using a second light source, heating the display apparatus to complete alignment of liquid crystal molecules; the first alignment layer and the second alignment layer are provided on opposite sides of the first substrate and the second substrate respectively.

The first substrate includes a light shielding layer and a spacer; the manufacturing method also includes forming a pixel array on the first substrate and forming a photoresist on the second substrate; the pixel array is located between the first substrate and the first alignment layer; the photoresist is located between the second substrate and the second alignment layer.

The first substrate includes data lines and scanning lines; before exposing the first alignment layer on the first substrate for alignment with using the first light source, the manufacturing method also includes following steps.

A first mask plate and the first alignment layer are aligned with using the data lines and the scanning lines as aligning marks.

Before exposing the second alignment layer on the second substrate for alignment with using the second light source; the manufacturing method also includes a following step.

A second mask plate and the second alignment layer are aligned with using the data lines and the scanning lines as aligning marks.

The manufacturing method of the display apparatus according to the embodiment of the disclosure, firstly aligns the first alignment layer on the first substrate with using light of a first wavelength, after injecting liquid crystals between the first substrate and the second substrate and assembling the first substrate and the second substrate, then exposes the second alignment layer on the second substrate for alignment with using light of a second wavelength different from the first wavelength; as the process of the exposing the second alignment layer on the second substrate for alignment is after the cell process, i.e., the process of exposing the second alignment layer on the second substrate for alignment is after injecting liquid crystals between the first substrate and the second substrate and assembling the first substrate and the second substrate, thus for exposing the second alignment layer on the second substrate for alignment, data lines, scan lines, a light shielding layer or a spacer can be employed as aligning marks to align a mask plate and the second alignment layer; with respect to exposing the second alignment layer on the second substrate for alignment before the cell process in the exemplary technique, the disclosure solves a technical problem of being unable to align the liquid crystal molecules resulted from being unable to expose the alignment layer in the second substrate for alignment for the display apparatus of placing the light shielding layer and the spacer on the first substrate, thus realizes the alignment of the liquid crystal molecules in the display apparatus with the light shielding layer and the spacer placed on the first substrate.

### BRIEF DESCRIPTION OF THE DRAWINGS

FIG. 1 is a structural schematic view of a display apparatus according to an embodiment of the disclosure;

FIG. 2 is a flow chart of a manufacturing method of a display apparatus according to an embodiment of the disclosure;

FIG. 3a is a schematic view of distribution of directions of molecular chains of a first alignment layer in a sub-pixel with eight display domains according to an embodiment of the disclosure;

FIG. 3b is a schematic view of distribution of directions of molecular chains of a second alignment layer in a sub-pixel with eight display domains according to an embodiment of the disclosure;

FIG. 3c is a schematic view of aligned liquid crystal molecules in a sub-pixel with eight display domains according to an embodiment of the disclosure;

FIG. 4a is a schematic view of distribution of the direction of the molecular chain of the first display domain and the third display domain of a first alignment layer in a sub-pixel with four display domains according to an embodiment of the disclosure;

FIG. 4b is a schematic view of distribution of the direction of the molecular chain of the second display domain and the fourth display domain of a first alignment layer in a sub-pixel with four display domains according to an embodiment of the disclosure;

FIG. 4c is a schematic view of distribution of directions of molecular chains of the first display domain and the second display domain of a second alignment layer in a sub-pixel with four display domains according to an embodiment of the disclosure;

FIG. 4d is a schematic view of distribution of directions of molecular chains of the third display domain and the fourth display domain of a second alignment layer in a sub-pixel with four display domains according to an embodiment of the disclosure;

FIG. 4e is a schematic view of aligned liquid crystal molecules in a sub-pixel with four display domains according to an embodiment of the disclosure.

### DETAILED DESCRIPTION OF EMBODIMENTS

The disclosure will now be described in further detail with reference to the accompanying drawings and embodiments. The specific embodiments described herein are for the purpose of explaining the disclosure rather than limiting the disclosure. For the sake of convenience of description, only the parts related to the disclosure rather than the entire structure are shown in the drawings.

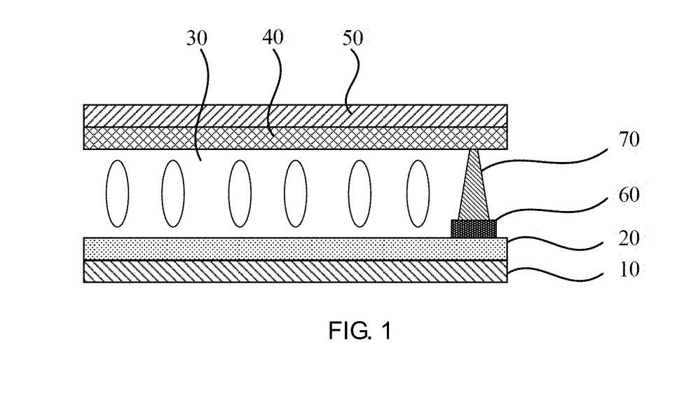

FIG. 1 is a structural schematic view of a display apparatus according to an embodiment of the disclosure; as shown in FIG. 1, the display apparatus includes a first substrate 10, a first alignment layer 20 on the first substrate 10, a second substrate 50, a second alignment layer 40 on the second substrate 50, and a liquid crystal layer 30 between the first substrate 10 and second substrate 50; the liquid crystal layer 30 includes liquid crystal molecules; the first alignment layer 20 and the second alignment layer 40 are provided on opposite sides of the first substrate 10 and the second substrate 50 respectively; the liquid crystal layer 30 is located between the first alignment layer 20 and the second alignment layer 40; the light shielding layer 60 and the spacer 70 are provided on the first substrate 10; the spacer is provided on the side of the light shielding layer remote from the first substrate in FIG. 1 exemplarily; the number of the light shielding layers and that of the spacers are equal to each other; the light shielding layer may be, for example, a black matrix; the spacer may be, for example, a support column. The embodiment of the disclosure is not limited to the arrangement of the light shielding layer and the spacer on the first substrate.

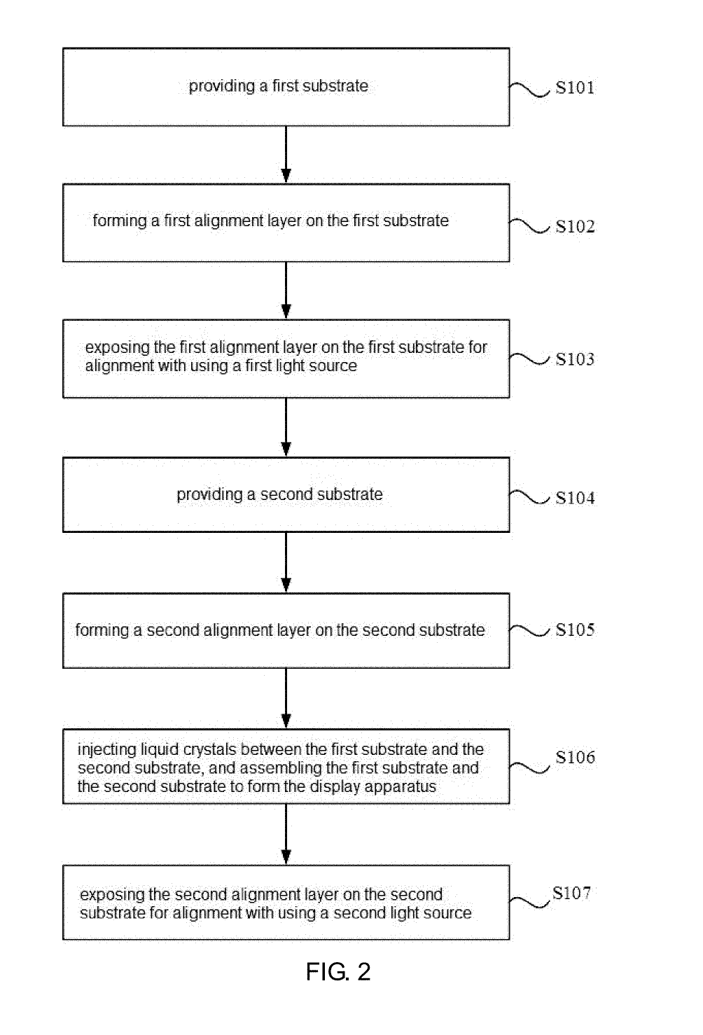

FIG. 2 is a flow chart of a manufacturing method of a display apparatus according to an embodiment of the disclosure; the manufacturing method according to the embodiment of the disclosure is applicable to a display apparatus with a light shielding layer and a spacer provided on a first substrate; and the manufacturing method according to the disclosure includes following steps.

S101, a first substrate is provided.

S102, a first alignment layer is formed on the first substrate.

S103, the first alignment layer on the first substrate is exposed for alignment with using a first light source.

S104, a second substrate is provided.

S105, a second alignment layer is formed on the second substrate.

S106, liquid crystals are injected between the first substrate and the second substrate, and the first substrate and the second substrate are assembled to form the display apparatus.

Exemplarily, the first substrate and the second substrate may be assembled through a sealant; particularly, the sealant may be formed on the first substrate to form a closed space for accommodating liquid crystals, and after instilling the liquid crystals, the first substrate and the second substrate are assembled to form the display apparatus; the sealant may further be formed on the second substrate to form a closed space for accommodating liquid crystals, and after instilling the liquid crystals, the first substrate and the second substrate are assembled to form a display apparatus.

S107, the second alignment layer on the second substrate is exposed for alignment with using a second light source.

Optionally, the above-described manufacturing method may further include: heating the display apparatus to complete alignment of liquid crystal molecules.

In one embodiment, the manufacturing method of the display apparatus according to the embodiment of the disclosure further includes forming a pixel array on the first substrate and forming a photoresist on the second substrate; the pixel array is located between the first substrate and the first alignment layer; the photoresist is located between the second substrate and the second alignment layer. The manufacturing method of the display apparatus may also include methods of forming a polarizer, a pixel driving circuit, and the like. The previous methods are too well-known in the art to be explained herein.

In another embodiment, the manufacturing method of the display apparatus according to the embodiment of the disclosure further includes forming a pixel array and a photoresist on the first substrate; the pixel array is located between the first substrate and the first alignment layer.

The manufacturing method of the display apparatus according to the embodiment of the disclosure, firstly aligns the first alignment layer 20 on the first substrate 10 with using the first light source, after injecting liquid crystals between the first substrate 10 and the second substrate 50 and assembling the first substrate 10 and the second substrate 50, exposes the second alignment layer 40 on the second substrate 50 for alignment with using the second light source; as the process of the exposing the second alignment layer 40 on the second substrate 50 for alignment is after the cell process (assembling the first substrate 10 and the second substrate 50), i.e., the process of the exposing the second alignment layer 40 on the second substrate 50 for alignment is after injecting liquid crystals between the first substrate 10 and the second substrate 50 to form the liquid crystal layer 30 and assembling the first substrate 10 and the second substrate 50, thus for exposing the second alignment layer 40 on the second substrate 50 for alignment, data lines, scan lines, a light shielding layer or a spacer can be employed as aligning marks to align a mask plate and the second alignment layer 40; with respect to exposing the second alignment layer 40 on the second substrate 50 for alignment before the cell process in the exemplary technique, the disclosure solves a technical problem of being unable to align the liquid crystal molecules resulted from being unable to expose the alignment layer in the second substrate for alignment in the display apparatus with the light shielding layer and the spacer placed on the first substrate, thus realizes the alignment of the liquid crystal molecules in the display apparatus with the light shielding layer and the spacer placed on the first substrate.

Optionally, the direction of the molecular chain of the first alignment layer after exposing the first alignment layer on the first substrate for alignment with using the first light source is perpendicular to the direction of the molecular chain of the second alignment layer after exposing the second alignment layer on the second substrate for alignment with using the second light source. Light emitted from the first light source irradiates the first alignment layer so that the molecular chains in the first alignment layer are directed in a specific direction, and light emitted from the second light source irradiates the second alignment layer so that the molecular chains in the second alignment layer are directed in a specific direction; the function of the directions of the molecular chains is similar to the function of the parallel grooves formed through friction in the friction orientation, and has an effect of forming the liquid crystal molecules with a pre-tilt angle; the directions of the molecular chains are related to the irradiation direction, the polarization direction and the intensity and the like of the light.

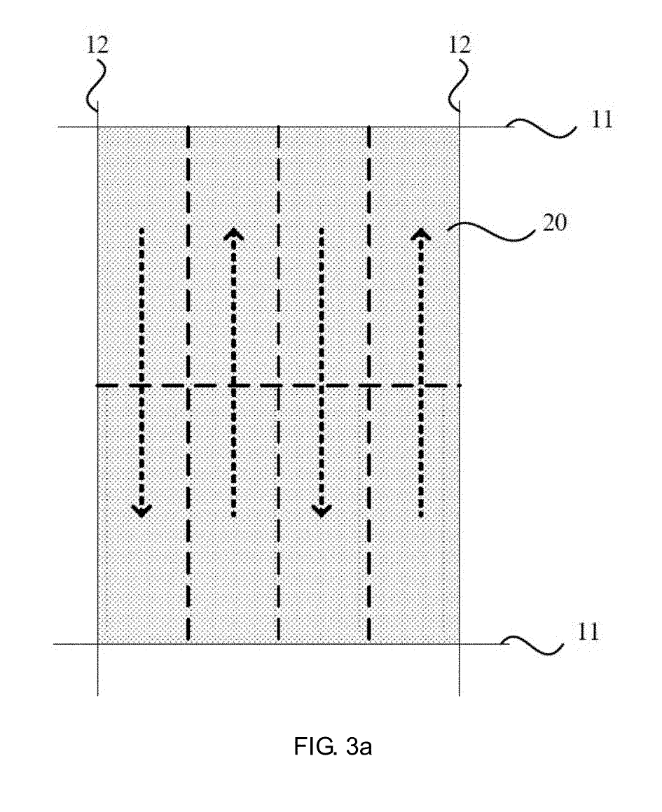

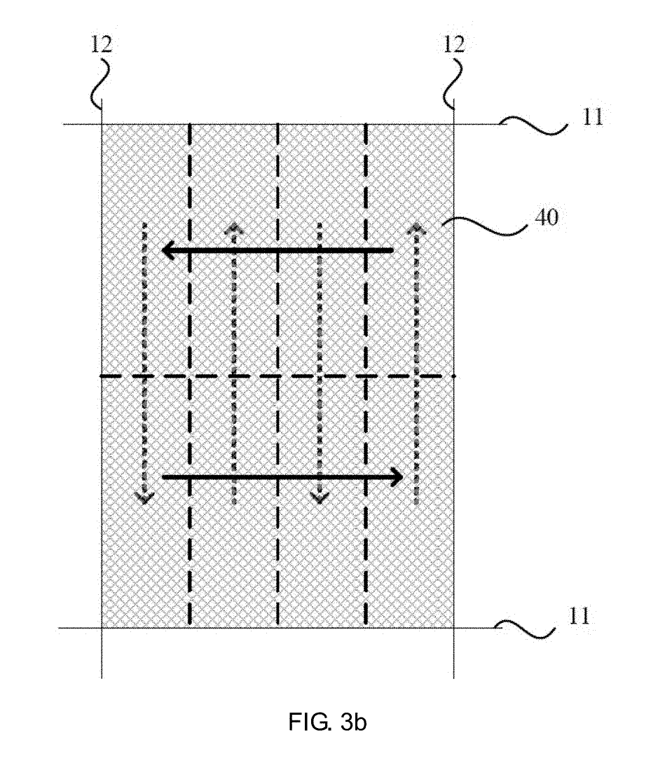

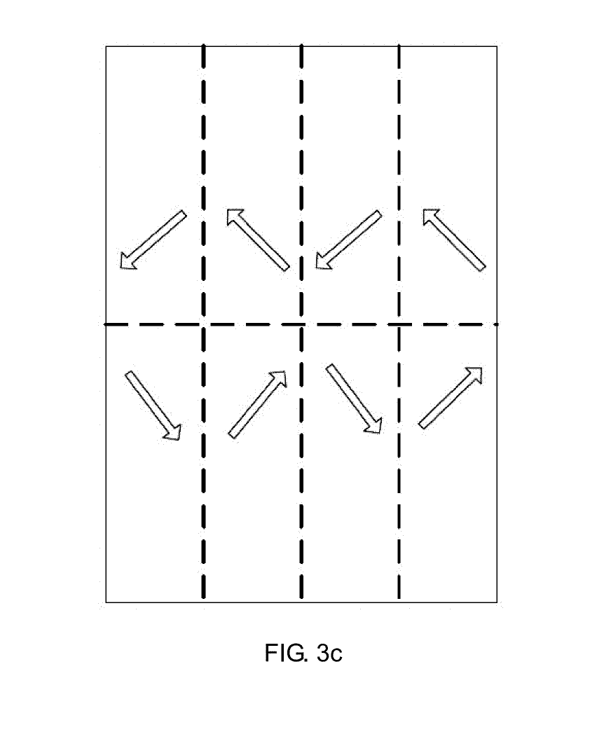

The first substrate may include data lines and scanning lines; the data lines and the scanning lines are insulated and crossed to define the sub-pixels; each of the sub-pixels includes display domains. FIG. 3a is a schematic view of distribution of directions of molecular chains of a first alignment layer in a sub-pixel with eight display domains according to an embodiment of the disclosure; FIG. 3b is a schematic view of distribution of directions of molecular chains of a second alignment layer in a sub-pixel with eight display domains according to an embodiment of the disclosure; FIG. 3c is a schematic view of aligned liquid crystal molecules in a sub-pixel with eight display domains according to an embodiment of the disclosure; as shown in FIGS. 3a, 3b and 3c, the directions of the dotted arrows indicate the directions of the molecular chains of the first alignment layer; the directions of the solid narrow arrows indicate the directions of the molecular chains of the second alignment layer; the directions of the solid broad arrows indicate the rotation directions of the liquid crystal molecules; the sub-pixel defined in an insulated and cross way through the scanning lines 11 and the data lines 12 includes eight display domains; the directions of the molecular chains of the first alignment layer 20 of the first substrate corresponding to two adjacent display domains are opposite along the extension direction of the scanning lines 11; the directions of the molecular chains of the first alignment layer 20 of the first substrate corresponding to two adjacent display domains are identical along the extension direction of the data lines 11; the directions of the molecular chains of the second alignment layer 40 of the second substrate corresponding to two adjacent display domains are opposite along the extension direction of the data lines 12; the directions of the molecular chains of the second alignment layer 40 of the second substrate corresponding to two adjacent display domains are identical along the extension direction of the scanning lines 11.

Another disposition can likewise be adopted. The directions of the molecular chains of the first alignment layer of the first substrate corresponding to two adjacent display domains are opposite along the extension direction of the data line; the directions of the molecular chains of the first alignment layer of the first substrate corresponding to two adjacent display domains are identical along the extension direction of the scanning line; the directions of the molecular chains of the second alignment layer of the second substrate corresponding to two adjacent display domains are opposite along the extension direction of the scanning line; the directions of the molecular chains of the second alignment layer of the second substrate corresponding to two adjacent display domains are identical along the extension direction of the data line.

The embodiments of the disclosure are not limited to the number of the display domains in each sub-pixel, or the manner of forming the display domain through combining the first alignment layer and the second alignment layer, for example, four domains can be formed on the first alignment layer with directions of adjacent molecular chains opposite to each other, and two domains can be formed on the second alignment layer with directions of adjacent molecular chains opposite to each other; then eight display domains are formed through the first alignment layer and the second alignment layer; likewise, two domains can be formed on the first alignment layer with directions of the adjacent molecular chains opposite to each other, and four domains can be formed on the second alignment layer with directions of the adjacent molecular chains opposite to each other, then eight display domains are formed through the first alignment layer and the second alignment layer.

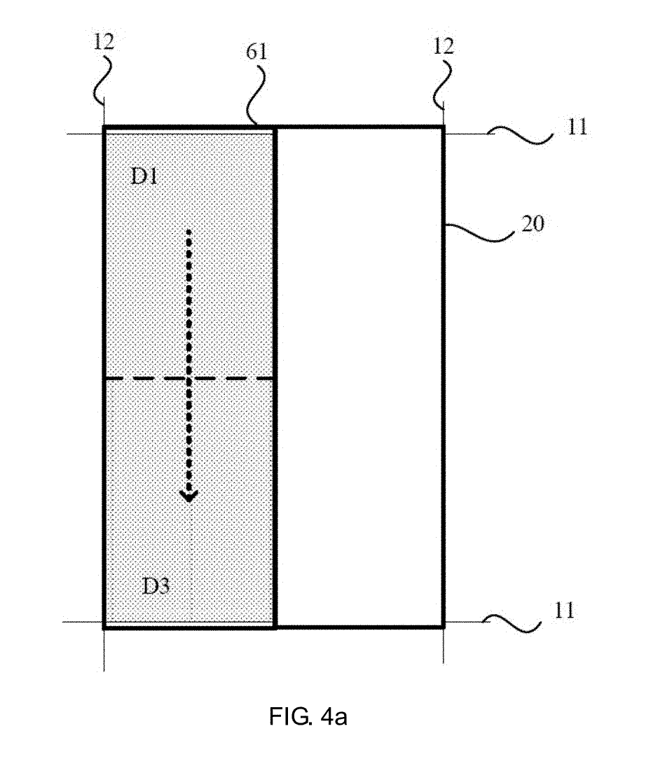

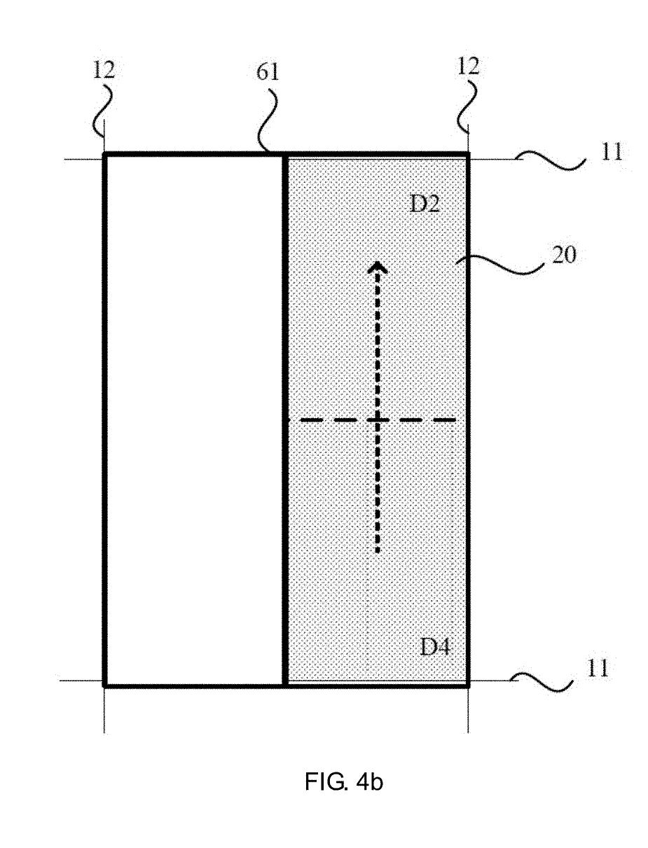

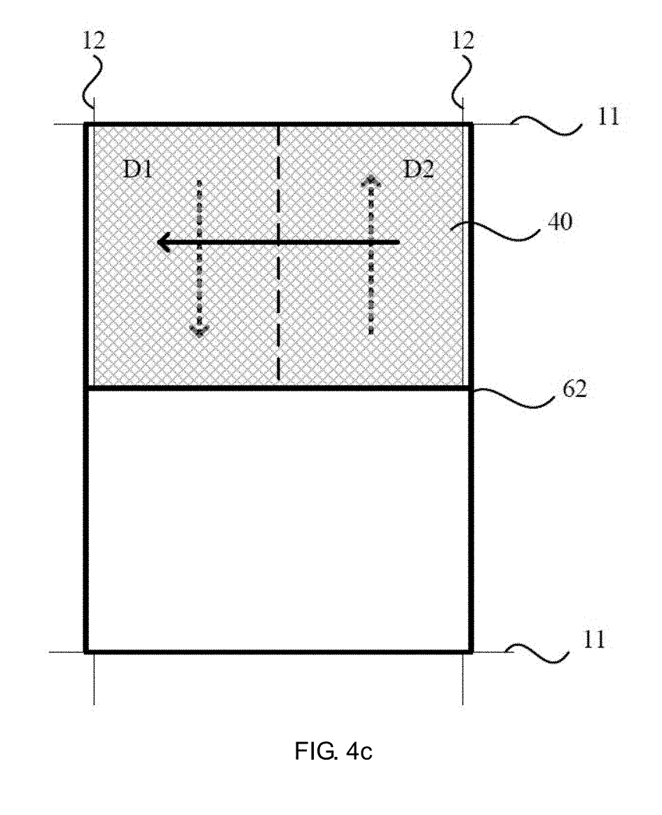

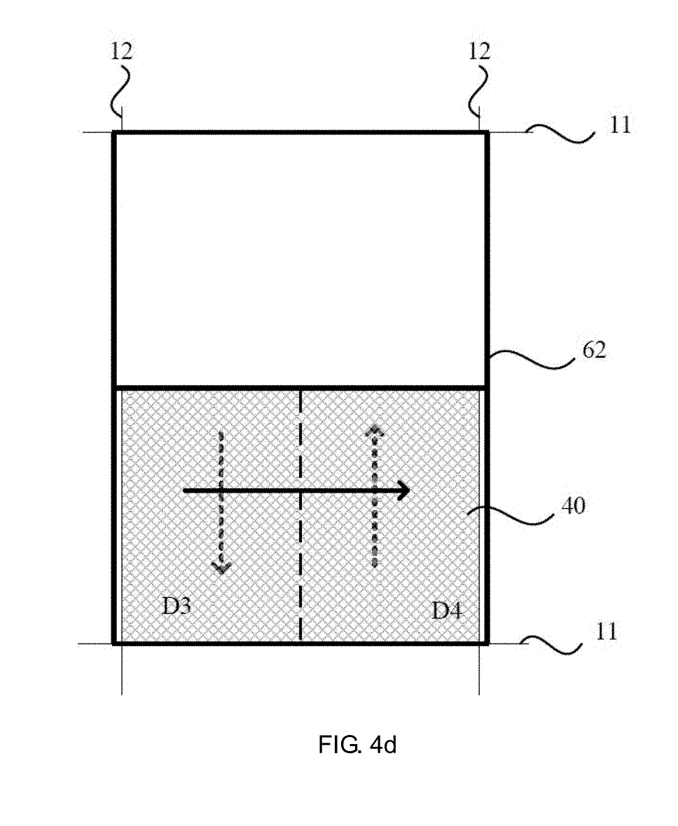

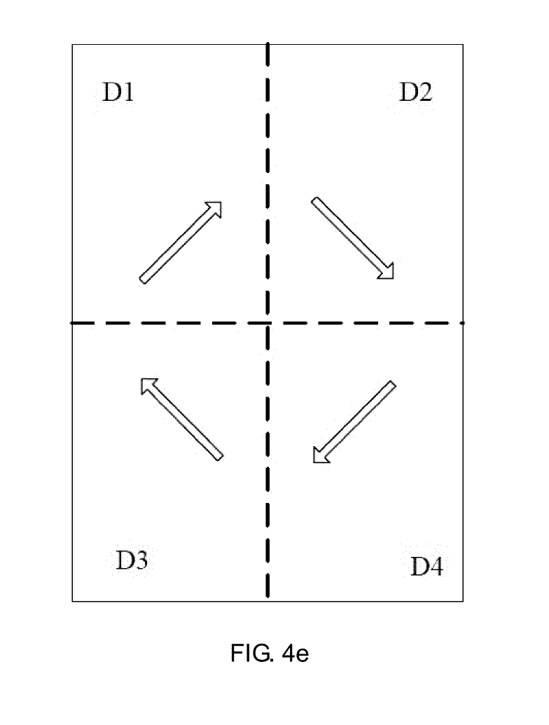

FIG. 4a is a schematic view of distribution of the direction of the molecular chain of the first display domain and the third display domain of a first alignment layer in a sub-pixel with four display domains according to an embodiment of the disclosure; FIG. 4b is a schematic view of distribution of the direction of the molecular chain of the second display domain and the fourth display domain of a first alignment layer in a sub-pixel with four display domains according to an embodiment of the disclosure; FIG. 4c is a schematic view of distribution of directions of molecular chains of the first display domain and the second display domain of a second alignment layer in a sub-pixel with four display domains according to an embodiment of the disclosure; FIG. 4d is a schematic view of distribution of directions of molecular chains of the third display domain and the fourth display domain of a second alignment layer in a sub-pixel with four display domains according to an embodiment of the disclosure; FIG. 4e is a schematic view of aligned liquid crystal molecules in a sub-pixel with four display domains according to an embodiment of the disclosure; the first substrate includes data lines and scanning lines; the data lines and the scanning lines are insulated and crossed to define the sub-pixels; referring to FIGS. 4a-4e, each of sub-pixels includes a first display domain D1, a second display domain D2, a third display domain D3, and a fourth display domain D4 arranged in a 2×2 matrix. The first display domain D1 and the second display domain D2 are arranged in a same row; the third display domain D3 and the fourth display domain D4 are arranged in a same row; the first display domain D1 and the third display domain D3 are arranged in a same column; the second display domain D2 and the fourth display domain D4 are arranged in a same column.

Referring to FIGS. 4a and 4b, the directions of the dashed arrows indicate the directions of the molecular chains of the first alignment layer, and exposing the first alignment layer 20 on the first substrate for alignment with using a first light source (not shown) includes: exposing the first alignment layer 20 on the first substrate corresponding to the first display domain D1 and the third display domain D3 for alignment with using light of a first wavelength through first mask plate 61; the first mask plate 61 exposes the first display domain D1 and the third display domain D3 of each sub-pixel, such that the direction of the molecular chains of the first alignment layer 20 on the first substrate corresponding to the first display domain D1 and the third display domain D3 is a first direction, namely the direction indicated through the dotted arrow in FIG. 4a. Exposing the first alignment layer 20 on the first substrate corresponding to the second display domain D2 and the fourth display domain D4 for alignment with using a first light source 61 (not shown), the first mask plate 61 exposes the second display domain D2 and the fourth display domain D4 of each sub-pixel, such that the direction of the molecular chains of the first alignment layer 20 on the first substrate corresponding to the second display domain D2 and the fourth display domain D4 is a second direction, namely the direction indicated through the dotted arrow in FIG. 4b; the first direction is opposite to the second direction.

Referring to FIGS. 4c and 4d, the directions of the solid narrow arrows indicate the directions of the molecular chains of the second alignment layer. Exposing the second alignment layer on the second substrate for alignment with using a second light source (not shown) includes: exposing the second alignment layer 40 on the second substrate corresponding to the first display domain D1 and the second display domain D2 for alignment with using the second light source through a second mask plate 62, the second mask plate 62 exposes the first display domain D1 and the second display domain D2 of each sub-pixel, such that the direction of the molecular chains of the second alignment layer 40 on the second substrate corresponding to the first display domain D1 and the second display domain D2 is a third direction, namely the direction indicated through the solid narrow arrow in FIG. 4c. Exposing the second alignment layer 40 on the second substrate corresponding to the third display domain D3 and the fourth display domain D4 for alignment with using a second light source through the second mask plate 62, the second mask plate 62 exposes the third display domain D3 and the fourth display domain D4 of each sub-pixel, such that the direction of the molecular chains of the second alignment layer 40 on the second substrate corresponding to the third display domain D3 and the fourth display domain D4 is a fourth direction, namely the direction indicated through the solid narrow arrow in FIG. 4d; the third direction is opposite to the fourth direction.

Referring to FIG. 4e, the directions of the solid broad arrows indicate the rotation direction of the liquid crystal molecules; a subpixel divided into four display domains can provide a wide display angle. In addition, as numerous display domains can be divided without using bulges and slits, thus the aperture ratio obtained according to the method to align liquid crystal molecules in the embodiment of the disclosure is higher than the aperture ratio of the display apparatus divided into multiple display domains with using bulges, resulting in the higher transmittance.

On the basis of the above embodiment, optionally, the first alignment layer is a photo-cleavable type alignment polyimide film, and the second alignment layer is a photopolymerizable type alignment polyimide film. The first alignment layer and the second alignment layer each use the two types of alignment layers; the photo-cleavable type polyimide film and the photo-alignment type polyimide film can be utilized to effectively avoid the influence of light emitted from the second light source on the first alignment layer when the second alignment layer on the second substrate is exposed for alignment with using the second light source.

Optionally, the first light source emits light of a first wavelength; the second light source emits light of a second wavelength; the first wavelength and the second wavelength may be different; the first wavelength is in a range of 254 nm to 365 nm; the second wavelength is in a range of 254 nm to 365 nm.

Optionally, the first substrate includes data lines and scanning lines, and before exposing the first alignment layer on the first substrate for alignment with using the first light source, the manufacturing method also includes: aligning the first mask plate and the first alignment layer with using the data lines and the scanning lines as aligning marks;

Before exposing the second alignment layer on the second substrate for alignment, the manufacturing method also includes: aligning the second mask plate and the second alignment layer with using the data lines and the scanning lines as aligning marks. The light shielding layer and/or the spacer on the first substrate can further be used as aligning marks to achieve the alignment of the first mask plate and the first alignment layer, and achieve the alignment of the second mask plate and the second alignment layer.

The light of the first wavelength and the light of the second wavelength may be polarized light; a direction of polarization of the light of the first wavelength is the same as a direction of polarization of the light of the second wavelength, and a direction of irradiation and scanning of the light of the first wavelength is orthogonal to a direction of irradiation and scanning of the light of the second wavelength. A method of forming light having a first wavelength in a predetermined direction of polarization, for example, may be realized through irradiating a linear polarizer with a light source of a first wavelength, and similarly, a method of forming light having a second wavelength of a predetermined direction of polarization, for example, may be realized through irradiating a linear polarizer with a light source of a second wavelength; as a direction of polarization of the light of the first wavelength is the same as a direction of polarization of the light of the second wavelength, and a direction of irradiation and scanning of the light of the first wavelength is orthogonal to a direction of irradiation and scanning of the light of the second wavelength of light, therefore, in the process of exposing the first alignment layer and the second alignment layer of the display apparatus for alignment, the same polarizer and light sources having different wavelengths may be used; after finishing the alignment of the first alignment layer with the light of first wavelength with using a light source of first wavelength, during exposing the second alignment layer for alignment, the second alignment layer may be rotated through 90° and then the light of the second wavelength is used to align the second alignment layer with using a light source of second wavelength.

The embodiment of the disclosure provides a manufacturing method of a display apparatus; the method includes: providing a first substrate, forming a first alignment layer on the first substrate, exposing the first alignment layer on the first substrate for alignment with using a first light source, providing a second substrate, forming a second alignment layer on the second substrate, injecting liquid crystals between the first substrate and the second substrate, and assembling the first substrate and the second substrate to form the display apparatus, exposing the second alignment layer on the second substrate for alignment with using a second light source, and heating the display apparatus to complete alignment of liquid crystal molecules; the first alignment layer and the second alignment layer are provided on opposite sides of the first substrate and the second substrate respectively.

The first substrate includes a light shielding layer and a spacer; the manufacturing method of the display apparatus also includes forming a pixel array on the first substrate and forming a photoresist on the second substrate; the pixel array is located between the first substrate and the first alignment layer; the photoresist is located between the second substrate and the second alignment layer.

The first substrate includes data lines and scanning lines, and before exposing the first alignment layer on the first substrate for alignment with using the first light source, the manufacturing method also includes aligning a first mask plate and the first alignment layer with using the data lines and the scanning lines as aligning marks.

Before exposing the second alignment layer on the second substrate for alignment with using the second light source, the manufacturing method also includes: aligning a second mask plate and the second alignment layer with using the data lines and the scanning lines as aligning marks.

The above only belongs to specific embodiments of the disclosure and the technical principles used herein. Those skilled in the art can understand the disclosure is not limited to the specific embodiments described herein and various changes, modifications and substitutions can be made from those skilled in the art without departing from the scope of the disclosure. Accordingly, although the disclosure has been described in more detail in a way of the above embodiments, the disclosure is not limited to the above embodiments, and other equivalent embodiments may be included without departing from the spirit of the disclosure; the scope of the disclosure is determined according to the scope of the appended claims.

What is claimed is:

1. A manufacturing method of a display apparatus, comprising:
providing a first substrate;
forming a first alignment layer on the first substrate;
exposing the first alignment layer on the first substrate for alignment with using a first light source;
providing a second substrate;
forming a second alignment layer on the second substrate;
injecting liquid crystals between the first substrate and the second substrate, and assembling the first substrate and the second substrate to form the display apparatus;
exposing the second alignment layer on the second substrate for alignment with using a second light source; the first alignment layer and the second alignment layer are provided on opposite sides of the first substrate and the second substrate respectively.

2. The manufacturing method as claimed in claim 1, wherein a direction of a molecular chain of the first alignment layer after exposing the first alignment layer on the first substrate for alignment is perpendicular to a direction of a molecular chain of the second alignment layer after exposing the second alignment layer on the second substrate for alignment.

3. The manufacturing method as claimed in claim 2, wherein the first substrate comprises a plurality of data lines and a plurality of scanning lines, the plurality of data lines and the plurality of scanning lines are insulated and crossed to define a plurality of sub-pixels; each of the plurality of sub-pixels comprises a plurality of display domains;
the directions of the molecular chains of the first alignment layer of the first substrate corresponding to two adjacent display domains are opposite along an extension direction of the plurality of data lines; the directions of the molecular chains of the first alignment layer of the first substrate corresponding to two adjacent display domains are identical along an extension direction of the plurality of scanning lines; the directions of the molecular chains of the second alignment layer of the second substrate corresponding to two adjacent display domains are opposite along the extension direction of the plurality of scanning lines; the directions of the molecular chains of the second alignment layer of the second substrate corresponding to two adjacent display domains are identical along the extension direction of the plurality of data lines;
or,
the directions of the molecular chains of the first alignment layer of the first substrate corresponding to two adjacent display domains are opposite along the extension direction of the plurality of scanning lines; the directions of the molecular chains of the first alignment layer of the first substrate corresponding to two adjacent display domains are identical along the extension direction of the plurality of data lines; the directions of the molecular chains of the second alignment layer of the second substrate corresponding to two adjacent display domains are opposite along the extension direction of the plurality of data lines; the directions of the molecular chains of the second alignment layer of the second substrate corresponding to two adjacent display domains are identical along the extension direction of the plurality of scanning lines.

4. The manufacturing method as claimed in claim 3, wherein the first substrate comprises the plurality of data lines and the plurality of scanning lines, the plurality of data lines and the plurality of scanning lines are insulated and crossed to define the plurality of sub-pixels; each of the sub-pixels comprises a first display domain, a second display domain, a third display domain, and a fourth display domain arranged in a 2×2 matrix; wherein the first display domain and the second display domain are arranged in a same row; the third display domain and the fourth display domain are arranged in a same row; the first display domain and the third display domain are arranged in a same column, the second display domain and the fourth display domain are arranged in a same column;
wherein exposing the first alignment layer on the first substrate for alignment with using the first light source comprises following steps:
exposing the first alignment layer on the first substrate corresponding to the first display domain and the third display domain for alignment, a first mask plate exposes the first display domain and the third display domain of each of the sub-pixels, such that the direction of the molecular chain of the first alignment layer on the first substrate corresponding to the first display domain and the third display domain is a first direction;
exposing the first alignment layer on the first substrate corresponding to the second display domain and the fourth display domain for alignment, the first mask plate exposes the second display domain and the fourth display domain of each of the sub-pixels, such that the direction of the molecular chain of the first alignment layer on the first substrate corresponding to the second display domain and the fourth display domain is a second direction; the first direction is opposite to the second direction;
wherein exposing the second alignment layer on the second substrate for alignment with using the second light source comprises following steps:
exposing the second alignment layer on the second substrate corresponding to the first display domain and the second display domain for alignment, a second mask plate exposes the first display domain and the second display domain of each of the sub-pixels, such that the direction of the molecular chain of the second alignment layer on the second substrate corresponding to the first display domain and the second display domain is a third direction;
exposing the second alignment layer on the second substrate corresponding to the third display domain and the fourth display domain for alignment, the second mask plate exposes the third display domain and the fourth display domain of each of the sub-pixels, such that the direction of the molecular chain of the second alignment layer on the second substrate corresponding to the third display domain and the fourth display domain is a fourth direction; the third direction is opposite to the fourth direction.

5. The manufacturing method as claimed in claim 1, wherein the first alignment layer is a photo-cleavable type alignment polyimide film.

6. The manufacturing method as claimed in claim 1, wherein the second alignment layer is a photopolymerizable type alignment polyimide film.

7. The manufacturing method as claimed in claim 1, wherein the first light source emits light of a first wavelength, the first wavelength is in a range of 254 nm to 365 nm.

8. The manufacturing method as claimed in claim 1, wherein the second light source emits light of a second wavelength, the second wavelength is in a range of 254 nm to 365 nm.

9. The manufacturing method as claimed in claim 1, wherein the first substrate comprises a plurality of data lines and a plurality of scanning lines; before exposing the first alignment layer on the first substrate for alignment with using the first light source, the manufacturing method also comprises a following step:
aligning a first mask plate and the first alignment layer with using the plurality of data lines and the plurality of scanning lines as aligning marks;
before exposing the second alignment layer on the second substrate for alignment with using the second light source, the manufacturing method also comprises a following step:
aligning a second mask plate and the second alignment layer with using the plurality of data lines and the plurality of scanning lines as aligning marks.

10. The manufacturing method as claimed in claim 1, wherein the first light source emits light of a first wavelength, the second light source emits light of a second wavelength;
the light of the first wavelength and the light of the second wavelength are polarized light, a direction of polarization of the light of the first wavelength is the same as a direction of polarization of the light of the second wavelength, and a direction of irradiation and scanning of the light of the first wavelength is orthogonal to a direction of irradiation and scanning of the light of the second wavelength.

11. The manufacturing method as claimed in claim 1, wherein the first substrate comprises a light shielding layer and a spacer, the manufacturing method also comprises forming a pixel array on the first substrate and forming a photoresist on the second substrate, the pixel array is located between the first substrate and the first alignment layer, the photoresist is located between the second substrate and the second alignment layer.

12. The manufacturing method as claimed in claim 1, wherein the first substrate comprises a light shielding layer and a spacer, the manufacturing method also comprises forming a pixel array and a photoresist on the first substrate, the pixel array is located between the first substrate and the first alignment layer.

13. The manufacturing method as claimed in claim 1, wherein the first substrate and the second substrate are assembled through a sealant.

14. The manufacturing method as claimed in claim 1, wherein light emitted from the first light source irradiates the first alignment layer so that molecular chains in the first alignment layer are distributed in a specific direction, playing a role of admitting liquid crystal molecules to form a pre-tilt angle.

15. The manufacturing method as claimed in claim 1, wherein light emitted from the second light source irradiates the second alignment layer so that molecular chains in the second alignment layer are distributed in a specific direction, playing a role of admitting liquid crystal molecules to form a pre-tilt angle.

16. A manufacturing method of a display apparatus, wherein the manufacturing method comprises:
providing a first substrate;
forming a first alignment layer on the first substrate;
exposing the first alignment layer on the first substrate for alignment with using a first light source;
providing a second substrate;
forming a second alignment layer on the second substrate;
injecting liquid crystals between the first substrate and the second substrate, and assembling the first substrate and the second substrate to form the display apparatus;
exposing the second alignment layer on the second substrate for alignment with using a second light source; wherein the first alignment layer and the second alignment layer are provided on opposite sides of the first substrate and the second substrate respectively,
heating the display apparatus to complete alignment of liquid crystal molecules;
wherein the first substrate comprises a light shielding layer and a spacer, the manufacturing method also comprises forming a pixel array on the first substrate and forming a photoresist on the second substrate, the pixel array is located between the first substrate and the first alignment layer, the photoresist is located between the second substrate and the second alignment layer;
the first substrate comprises a plurality of data lines and a plurality of scanning lines, before exposing the first alignment layer on the first substrate for alignment with using the first light source, the manufacturing method also comprises following steps:
aligning a first mask plate and the first alignment layer with using the plurality of data lines and the plurality of scanning lines as aligning marks;
aligning a second mask plate and the second alignment layer with using the plurality of data lines and the plurality of scanning lines as aligning marks, before exposing the second alignment layer on the second substrate for alignment with using the second light source.

17. The manufacturing method as claimed in claim 16, wherein a direction of a molecular chain of the first alignment layer after exposing the first alignment layer on the first substrate for alignment is perpendicular to a direction of a molecular chain of the second alignment layer after exposing the second alignment layer on the second substrate for alignment.

18. The manufacturing method as claimed in claim 16, wherein the first substrate and the second substrate are assembled through a sealant.

19. The manufacturing method as claimed in claim 16, wherein light emitted from the first light source irradiates the first alignment layer so that molecular chains in the first alignment layer are distributed in a specific direction, playing a role of admitting liquid crystal molecules to form a pre-tilt angle.

20. The manufacturing method as claimed in claim 16, wherein light emitted from the second light source irradiates the second alignment layer so that molecular chains in the second alignment layer are distributed in a specific direction, playing a role of admitting liquid crystal molecules to form a pre-tilt angle.
